(19) United States
(12) Patent Application Publication
(10) Pub. No.: US 2025/0053418 A1
(43) Pub. Date: Feb. 13, 2025

(54) IMPLEMENTING TECHNICAL DOCUMENTATION BASED ON TECHNICAL ENTITLEMENT

(71) Applicant: International Business Machines Corporation, Armonk, NY (US)

(72) Inventors: Jeffrey BISTI, New Paltz, NY (US); Colton Jarrett COX, Wappingers Falls, NY (US); Justin Paul LARGO, Raleigh, NC (US)

(21) Appl. No.: 18/366,236

(22) Filed: Aug. 7, 2023

(51) Int. Cl. G06F 8/73

(52) U.S. Cl. CPC G06F 8/73

(57) ABSTRACT

Embodiments of the present disclosure provide systems and methods for implementing customized technical documentation sets for multiple local system environments of an enterprise computer system based on entitled technology and context. A disclosed method comprises accessing a technical documentation library of an enterprise computer system and scanning the technical documentation library based on technical entitlements of a given system environment to generate a customized technical documentation set. The system monitors DevOps to trigger a new scan of the customized technical documentation set based on technical entitlements of the given system environment that provides new scan results. The system revises the customized technical documentation set based on the new scan results for the given system environment.

### BACKGROUND

The present invention relates to digital data processing, and more specifically, to systems and methods for implementing customized technical documentation sets based on entitled technology and context in an enterprise computer system.

A technical documentation library or documentation repository for an enterprise computer system can include a vast quantity of technical documentation extending across hardware, middleware, and software. Such technical documentation typically spans a complex multitude of interconnected components and environments as a combination of software, programming languages, computer platforms, and data storage technologies. Often key concepts, usage guides, and troubleshooting guidance are located in entirely different parts of a given library or possibly across entirely different libraries. A user's search of an existing enterprise system level documentation library can provide results that are not relevant to their query and may return results of features not actively used by their system.

A need exists for a system and method for implementing technical documentation in a given system environment of an enterprise computer system to facilitate ready access and use of technical documentation relevant to entitled technology or technical entitlements available to enterprise technology users in the given system environment, such as available directly related software, hardware, and middleware and associated relevant documentation of the technology users.

### SUMMARY

Embodiments of the present disclosure provide systems and methods for implementing customized technical documentation sets for multiple system environments of an enterprise computer system based on entitled technology and context.

A disclosed non-limiting computer implemented method comprises accessing a technical documentation library of an enterprise computer system and scanning the technical documentation library based on technical entitlements of a given system environment to generate a customized technical documentation set for the given system environment. The system monitors DevOps to trigger a new scan of the customized technical documentation set based on technical entitlements of the given system environment to provide new scan results. The system revises the customized technical documentation set based on the new scan results.

Other disclosed embodiments include a computer system and computer program product implementing customized technical documentation sets for multiple system environments of an enterprise computer system based on entitled technology and context, implementing features of the above-disclosed method

### BRIEF DESCRIPTION OF THE DRAWINGS

FIG. 1 is a block diagram of an example computer environment for use in conjunction with one or more embodiments for implementing enhanced technical documentation based on entitled technology and context;

FIG. 2 is a block diagram of an example system for implementing enhanced technical documentation based on entitled technology and context of one or more disclosed embodiments;

FIG. 3 is a flow chart of example operations of a method for implementing enhanced technical documentation based on entitled technology and context of one or more disclosed embodiments;

FIG. 4 is a flow chart of example operations to provide NLP filtering for generating a custom documentation set for a given system of a method of one or more disclosed embodiments; and

FIG. 5 is a flow chart of an example method for implementing enhanced technical documentation based on entitled technology and context of one or more disclosed embodiments.

### DETAILED DESCRIPTION

Embodiments of the present disclosure provide systems and methods for implementing enhanced technical documentation based on entitled technology and context. In a disclosed embodiment, N unique, customized technical documentation sets or libraries are built for local system environments based on an enterprise-wide technical documentation repository in an enterprise computer system, each according to a respective local system environment. The customized technical documentation sets are tailored or updated to provide current relevant documentation by an automated assessment of technical entitlements at the local system environment level. In a disclosed embodiment, for each local system environment, DevOps events monitoring of the local system environment enables continually updating versions of the respective customized technical documentation sets, such as based on code check-ins, system configuration changes and/or new entitlements. Further, the customized technical documentation set or library can be manually refreshed through user input.

In a disclosed embodiment, local customized technical documentation sets are implemented utilizing page-level logic applied to an enterprise-wide technical documentation library of an enterprise-wide technical documentation repository in an enterprise computer system. In a disclosed embodiment, the system instantiates a customized technical documentation set based on perceived technical entitlements for a given system environment. In a disclosed embodiment, local customized technical documentation sets are automatically filtered for relevancy based on an enterprise user's entitled technology and through monitoring DevOps events, such as code check-ins triggered in a DevOps pipeline, resulting in a need to update the customized technical documentation set. A disclosed system updates the customized technical documentation set or library of a given local enterprise system environment, for example, when code is checked-in, new software is installed, a new entitlement is added, and the local enterprise system environment is reconfigured.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

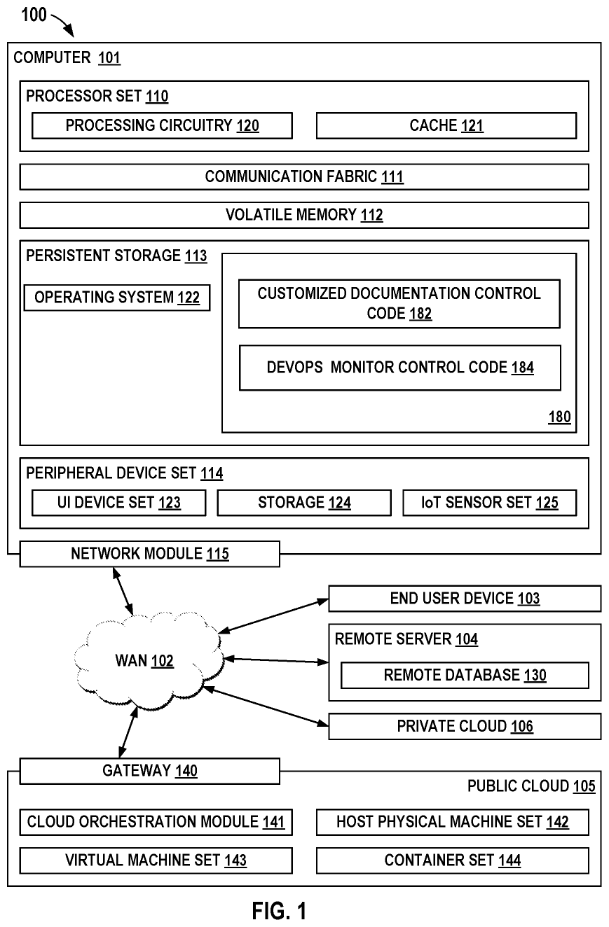

Referring to FIG. 1, a computing environment 100 contains an example of an environment for the execution of at least some of the computer code involved in performing the inventive methods, such as a Customized Documentation Control Code 182 and a DevOps Monitor Control Code 184, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present disclosure provide systems and methods for implementing customized technical documentation of an enterprise computer system based on entitled technology and context. In a disclosed embodiment, a locally stored version of an enterprise-scale technical documentation library, called a Customized Local Technical Documentation Set is augmented with: (a) page-level logic relating the content of a page to a perceived entitlement; (b) data regarding entitlements and usage, for example, obtained from specified approved sources, such as source code versions, program logs, and the like, contained locally to the local system, which are used only for client-side filtering of documentation assets; (c) a natural language processing model trained to associate specific contextual content to each given page; and (d) a function to monitor DevOps changes to the associated local system, including code check-ins and entitlement changes.

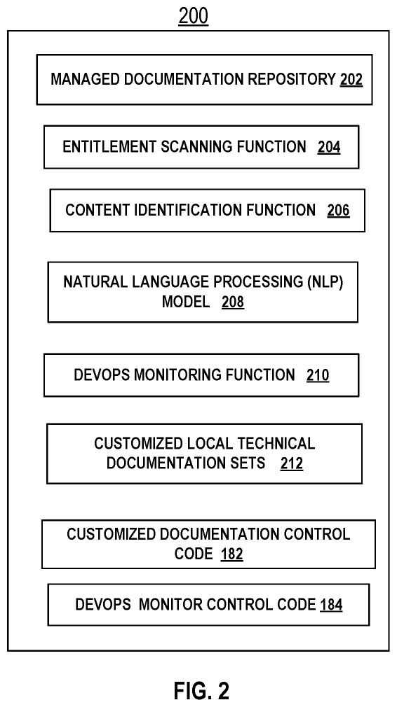

FIG. 2 illustrates an example system 200 for implementing enhanced technical documentation based on entitled technology and context of one or more disclosed embodiments. System 200 can be used in conjunction with the computer 101 and cloud environment of the computing environment 100 and the Customized Documentation Control Code 182 and DevOps Monitor Control Code 184 of FIG. 1 for implementing enhanced technical documentation of disclosed embodiments.

System 200 includes a Managed Documentation Repository 202, which contains page level logic for implementing a customized technical documentation library of disclosed embodiments. For example, the Managed Documentation Repository 202 includes a full-scale enterprise-level technical documentation library of a large number N pages. The Managed Documentation Repository 202 comprises content about software, middleware, operational procedures, and is typically available across multiple versions. In a disclosed embodiment, the page level logic enables efficiently instantiating and updating a customized technical documentation set for each of multiple system environments of enterprise computer system 200. In a disclosed embodiment, for example the page level logic of system 200 includes an Entitlement Scanning Function 204, a Content Identification Function 206, and a Natural Language Processing (NLP) model 208 for implementing the respective customized technical documentation sets.

System 200 includes the Entitlement Scanning Function 204 used to analyze available technical entitlements of a given local system or system environment to provide a respective customized technical documentation set or library for each of the local system environments of disclosed embodiments. For example, system 200 uses the Entitlement Scanning Function 204 to scan the technical documentation library to identify corresponding technical documentation and associated relevant documentation contained in the technical documentation library which include the same or identical documentation corresponding to the technical entitlements of a given system environment. System 200 uses such identified documentation to instantiate a customized technical documentation set or library for the system environments. System 200 includes the Content Identification Function 206 used to identify content based on identified available technical entitlements of the Entitlement Scanning Function 204.

System 200 includes the Natural Language Processing (NLP) model 208 trained on a technical documentation library, which uses results of the Entitlement Scanning Function 204 and the Content Identification Function 206 to identify specific pages and chapters of documentation directly related to the given system's available software, and associated relevant documentation of contextual and pre-requisite pages that may be indirectly related to the specific pages and chapters of documentation. System 200 includes a DevOps Monitoring Function 210 to trigger a new entitlement scan after DevOps events are detected. System 200 includes Customized Local Technical Documentation Sets 212 implemented in accordance with disclosed embodiments. For example, the Customized Local Technical Documentation Sets 212 include multiple (N) unique, custom documentations libraries, each of which are tailored by an automated assessment of the technical entitlements of multiple local systems or environments of an enterprise computer system.

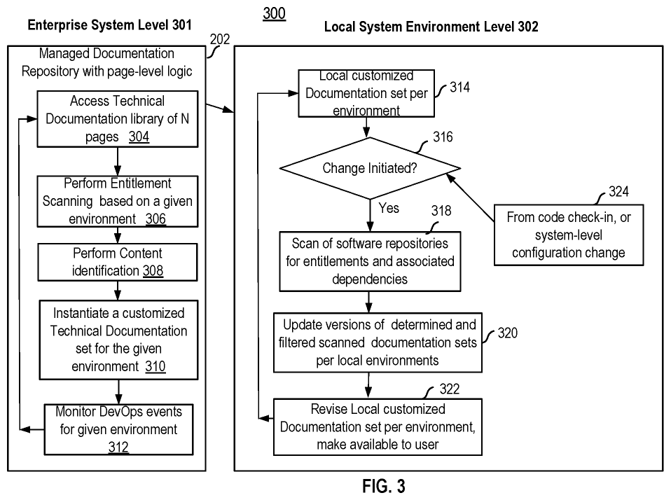

FIG. 3 illustrates example operations of a method 300 for implementing enhanced technical documentation based on entitled technology and context of one or more disclosed embodiments. In a disclosed embodiment, method 300 is implemented by system 200 in conjunction with the Customized Documentation Control Code 182, DevOps Monitor Control Code 184, and computer 101 of FIG. 1 in accordance with one or more disclosed embodiments of the present disclosure. As shown, method 300 includes example operations at an Enterprise System Level 301 and Local System Environment Level 302.

As shown at block 304, system 200 uses for example the Managed Documentation Repository 202 with page-level logic and accesses a Technical Documentation library of N pages of an enterprise computer system. At block 306, system 200 performs entitlement scanning of a given environment, where the enterprise computer system includes a plurality of respective local environments of respective technical system users. For example, a separate entitlement scan is performed at block 306 for each of the multiple respective local environments to instantiate respective customized technical documentation sets. At block 308, system 200 performs content identification based on entitlement scan results and data regarding actual technology usage in the multiple system environments of the enterprise computer system. For example, in a disclosed embodiment the natural language processing (NLP) model 208 is used in conjunction with the entitlement scanning function 204 and the content identification function 206 to determine a relevant scope and content of technical documentation at block 308.

At block 310, system 200 instantiates a customized Technical Documentation set for the given environment, which is made available to technical system users for that environment. At block 312, system 200 monitors DevOps events for the given environment for refreshing the customized Technical Documentation set through association with predefined DevOps events, such as code check-ins or predefined key actions taken by a technical user, such as a System Programmer.

In a disclosed embodiment, at the local system environment level 302 system 200 supplies logic to each respective customized Technical Documentation set per environment, where the local customized set of Technical Documentation content is based on perceived technical entitlements as indicated at block 314. Further, in a disclosed embodiment, system 200 augments each respective local customized technical documentation library or technical documentation set with page level logic including a natural language processing model to identify relevant contexts and pre-requisites based on perceived technical entitlements. In a disclosed embodiment, an individual environment within an enterprise computer system can copy a program file into their local repository, which can include page level logic of the Entitlement Scanning Function 204, Content Identification Function 206, Natural Language Processing (NLP) model 208 and DevOps Monitoring Function 210 of the Managed Documentation Repository 202.

At decision block 316, system 200 checks for an initiated change for one or more local system environments. At block 318, system 200 scans software repositories to identify entitlements and associated dependencies of a given one or more local system environments. In a disclosed embodiment, a given NLP model 208 filters the total documentation set to identify pages and chapters relevant specifically to that system, and the supporting contexts of the relevant technical documentation set at block 318. For example, the NLP model 208 is trained to associate contextual content to each given page of the relevant technical documentation set.

At block 320, system 200 updates versions of the determined and filtered scanned documentation sets per local environments. At block 322, system 200 implements a revised technical documentation set per environment where each respective local customized technical documentation set is replaced with the updated documentation collection at block 314. System 200 makes the respective updated local customized technical documentation available to users of the respective system environments at block 322.

At block 324, system 200 creates a DevOps event, triggering a new system scan, for example, the DevOps event includes one of: code is checked-in, new software is installed, a new entitlement is added, and the local enterprise system environment is reconfigured. In a disclosed embodiment, the local customized technical documentation sets are automatically filtered responsive to predefined DevOps events triggered in a DevOps pipeline of a given one or more local system environments to update changes and maintain the local customized technical documentation sets current. The local customized technical documentation sets are revised dynamically to accommodate newly available entitlements and contexts.

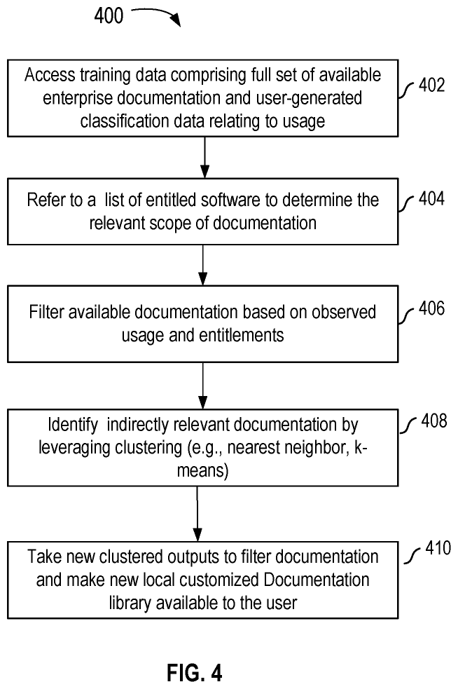

FIG. 4 illustrates example operations of a method 400 of NLP filtering for generating a custom documentation set for a given system of one or more disclosed embodiments. At block 402, system 200 accesses training data, for example comprising the full set of available enterprise documentation together with user-generated classification data about usage, used to train the NLP model 208. At block 404, system 200 references a list of entitled software to determine the relevant scope of documentation, for example using the NLP model 208.

At block 406, system 200 filters available documentation based on observed usage and technical entitlements. For example, the observed usage and technical entitlements includes use by a technical user or programmer of any entitled technology available to the local technology users in the given system environment, such as available software, hardware, middleware and associated relevant technical entitlements. At block 408, system 200 also identifies supporting relevant documentation for the entitled technology by leveraging clustering, for example, nearest neighbor, k-means clustering implemented by the NLP model 208. At block 410, system 200 takes the new clustered outputs to filter documentation and make a new local customized technical documentation set available to the user.

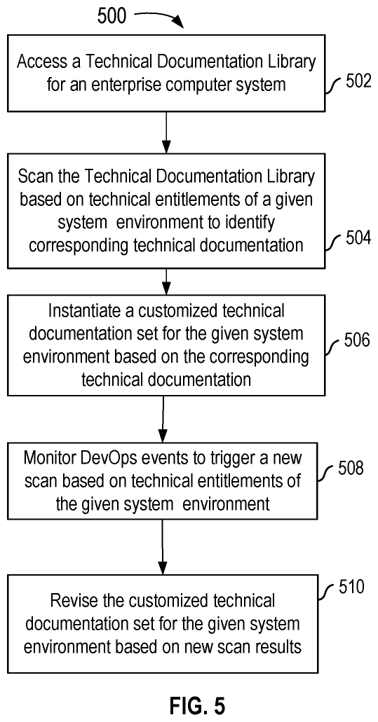

FIG. 5 is a flow chart of an example method for implementing enhanced technical documentation based on entitled technology and context of one or more disclosed embodiments.

At block 502, system 200 accesses a technical documentation library of an enterprise computer system to implement local customized technical documentation sets of disclosed embodiments. For example, the enterprise-wide technical documentation repository 202 includes the enterprise-wide technical documentation library accessed at block 502.

At block 504, system 200 scans the technical documentation library based on technical entitlements of a given system environment to identify technical documentation and associated relevant documentation in the technical documentation library corresponding to the technical entitlements of the given system environment. For example, the identified technical documentation and associated relevant documentation in the technical documentation library corresponds to available entitled software in the given system environment. System 200 filters the technical documentation library based on observed usage of the technical entitlements in the given system environment, for example based on user-generated classification data related to usage, at block 504. In a disclosed embodiment, for example the observed usage of technical entitlements includes use of any entitled technology available to the enterprise technology users in the given system environment, such as available software, hardware, middleware and associated relevant technical entitlements by a technical user, such as a system programmer. For example, the entitlement scanning function 204 analyzes the technical entitlements of a given system together with the content identification function 206 and the natural language processing model 208. At block 504, system 200 uses the results of the entitlement scanning function 204 to identify specific pages and chapters of documentation directly related and associated relevant documentation indirectly related to the system environment's software at block 504.

At block 506, system 200 instantiates a customized technical documentation set for the given system environment based on the corresponding technical documentation. An individual system environment within the system can copy the program file into their repository.

At block 508, system 200 monitors DevOps events to trigger a new scan based on the technical entitlements of the given system environment and identify new scan results. At block 510, system 200 revises the customized technical documentation set for the given system environment based on the new scan results. In a disclosed embodiment, system 200 dynamically updates the customized technical documentation set to accommodate new technical entitlements and technical documentation contexts at block 510. The revised customized technical documentation set is made available to users of the given system environment at block 510.

While the foregoing is directed to embodiments of the present invention, other and further embodiments of the invention may be devised without departing from the basic scope thereof, and the scope thereof is determined by the claims that follow.

What is claimed is:

1. A method comprising:
accessing a technical documentation library of an enterprise computer system;
scanning the technical documentation library based on technical entitlements of a given system environment to identify technical documentation in the technical documentation library corresponding to the technical entitlements;
instantiating a customized technical documentation set for the given system environment based on the corresponding technical documentation;
monitoring DevOps events to trigger a new scan based on the technical entitlements of the given system environment to identify new scan results; and
revising the customized technical documentation set for the given system environment based on the new scan results.

2. The method of claim 1, wherein the technical documentation library of the enterprise computer system comprises an enterprise-wide technical documentation library of an enterprise-wide technical documentation repository in the enterprise computer system, the an enterprise-wide technical documentation library comprises content relating to one or more of software, middleware, of operational procedures.

3. The method of claim 1, wherein scanning the technical documentation library based on technical entitlements of the given system environment further comprises scanning the technical documentation library to identify technical documentation directly matching the technical entitlements of the given system environment and to identify associated relevant documentation.

4. The method of claim 1, wherein scanning the technical documentation library based on technical entitlements of the given system environment further comprises filtering the technical documentation library based on observed usage of the technical entitlements in the given system environment.

5. The method of claim 1, wherein scanning the technical documentation library based on technical entitlements of the given system environment further comprises analyzing the technical entitlements of the given system environment based on user-generated classification data related to usage.

6. The method of claim 1, wherein scanning the technical documentation library based on technical entitlements of the given system environment further comprises using a natural language processing model trained on the technical documentation library to identify specific pages of the technical documentation library related to technical documentation of the given system environment.

7. The method of claim 1, wherein monitoring the DevOps events to trigger the new scan based on the technical entitlements of the given system environment further comprises monitoring predefined actions taken by a technical user of the given system environment.

8. The method of claim 1, wherein monitoring the DevOps events to trigger the new scan further comprises automatically filtering the customized technical documentation set for the given system environment responsive to identifying a predefined DevOps event.

9. The method of claim 1, wherein monitoring the DevOps events to trigger the new scan further comprises monitoring DevOps events including one or more of when code is checked-in, a new software is installed, a new entitlement added, or the given system environment is reconfigured.

10. The method of claim 1, wherein revising the customized technical documentation set for the given system environment based on the new scan results further comprises dynamically updating the customized technical documentation set to accommodate new technical entitlements and technical documentation contexts.

11. A system, comprising:
a processor; and
a memory, wherein the memory includes a computer program product configured to perform operations for implementing customized technical documentation sets for multiple system environments of an enterprise computer system, the operations comprising:
accessing a technical documentation library of an enterprise computer system;
scanning the technical documentation library based on technical entitlements of a given system environment to identify technical documentation in the technical documentation library corresponding to the technical entitlements;
instantiating a customized technical documentation set for the given system environment based on the corresponding technical documentation;
monitoring DevOps events to trigger a new scan based on the technical entitlements of the given system environment and identify new scan results; and
revising the customized technical documentation set for the given system environment based on the new scan results.

12. The system of claim 11, wherein scanning the technical documentation library based on technical entitlements of the given system environment further comprises filtering the technical documentation library based on observed usage of the technical entitlements in the given system environment.

13. The system of claim 11, wherein scanning the technical documentation library based on technical entitlements of the given system environment further comprises using a natural language processing model trained on the technical documentation library to identify specific pages of the technical documentation library related to software of the given system environment.

14. The system of claim 11, wherein monitoring the DevOps events to trigger the new scan further comprises automatically filtering the customized technical documentation set for the given system environment responsive to identifying a predefined DevOps event.

15. The system of claim 11, wherein monitoring the DevOps events to trigger the new scan further comprises monitoring DevOps events including one or more of when code is checked-in, a new software is installed, a new entitlement added, or the given system environment is reconfigured.

16. A computer program product for implementing customized technical documentation sets for multiple system environments of an enterprise computer system, the computer program product comprising:
a computer-readable storage medium having computer-readable program code embodied therewith, the computer-readable program code executable by one or more computer processors to perform an operation comprising:
accessing a technical documentation library of an enterprise computer system;
scanning the technical documentation library based on technical entitlements of a given system environment to identify technical documentation in the technical documentation library corresponding to the technical entitlements;
instantiating a customized technical documentation set for the given system environment based on the corresponding technical documentation;
monitoring DevOps events to trigger a new scan based on the technical entitlements of the given system environment to identify new scan results; and
revising the customized technical documentation set for the given system environment based on the new scan results.

17. The computer program product of claim 16, wherein scanning the technical documentation library based on technical entitlements of the given system environment further comprises filtering the technical documentation library based on observed usage of the technical entitlements in the given system environment.

18. The computer program product of claim 16, wherein scanning the technical documentation library based on technical entitlements of the given system environment further comprises using a natural language processing model trained on the technical documentation library to identify specific pages of the technical documentation library related to software of the given system environment.

19. The computer program product of claim 16, wherein monitoring the DevOps events to trigger the new scan further comprises automatically filtering the customized technical documentation set for the given system environment responsive to identifying a predefined DevOps event.

20. The computer program product of claim 16, wherein monitoring the DevOps events to trigger the new scan further comprises monitoring DevOps events including one or more of when code is checked-in, a new software is installed, a new entitlement added, or the given system environment is reconfigured.
